(19) United States
(12) Patent Application Publication
(10) Pub. No.: US 2007/0118545 A1
(43) Pub. Date: May 24, 2007

(54) Dynamic business process integration using complex event processing

(75) Inventors: Sivakumar Chandrasekharan, Alameda, CA (US); Thomas Pollinger, Cupertino, CA (US); Radha Krishna Kanth Popuri, Mountain View, CA (US); Huai-Tsung Shang, Yonghe City (TW); Juliana Hing Sze Tsang, San Lorenzo, CA (US)

Correspondence Address: DUKE W. YEE, P.O. BOX 802333, YEE & ASSOCIATES, P.C., DALLAS, TX, 75380, US

(73) Assignee: International Business Machines Corporation, Armonk, NY (US)

(21) Appl. No.: 11/284,471

(22) Filed: Nov. 21, 2005

(51) Int. Cl. G06F 7/00

(52) U.S. Cl. 707/101

(57) ABSTRACT

An enterprise application integration broker for managing a number of applications. The enterprise application integration broker includes a complex event processing engine. The complex event processing engine is adapted to monitor and analyze a first set of events in at least one of the plurality of applications. In addition, the enterprise application integration broker includes an integration engine. The integration engine is connected to the complex event processing engine and is connected to each of the applications. The integration engine is adapted to cause at least one application to react to a first set of events occurring in one or more of the plurality of applications. The integration engine is further adapted to cause at least one application to react to a second set of events generated by the complex event processing engine. The second set of events is correlated with the first set of events.

### BACKGROUND OF THE INVENTION

1. Field of the Invention

The present invention relates generally to data processing systems and in particular, to enterprise application integration brokers. Still more particularly, the present invention relates to a computer implemented method, apparatus, and computer usable program code for an enterprise application integration broker having an integrated complex event processing engine.

2. Description of the Related Art

In modern, complex business operations, large numbers of computer-operated applications, running on a large number of computers, are used to conduct day-to-day business activities. For example, a business may rely on one application to receive customer orders, a second application to process customer orders, a third application to track customer information, a fourth application to manage inventory that changes in response to customer orders, a fifth application to handle shipping, and possibly numerous other applications. Coordinating these applications can be a daunting challenge. For example, a single customer order event may have a ripple effect in many other of the business applications. Manually adjusting all of a business' applications in response to such an event is impracticable.

The problem of managing multiple business applications has been addressed in the past. For example, applications known as enterprise application integration platforms have been developed that enables a business to integrate disparate applications. The integration platform includes an integration broker and a means for allowing a user to define the rules that govern how the broker manages or integrates the business applications.

For example, a business analyst can create a business process that includes a description of the order in which each application should take action and a description of the effect of an event on other applications. In a detailed example, a business analyst defines a business process in which a first application receives a customer order and a second application is to receive the order and charge the customer a fee on the customer's credit card. Then, if the credit card purchase is approved, a third application is to process the order. The enterprise application integration broker handles the interactions between each of these applications, ensuring that the process is carried out in the order defined by the business analyst according to the rules specified by the business analyst.

However, a problem associated with enterprise application integration brokers is that they only process business events emanating from one or more applications. Known enterprise application integration brokers do not analyze multiple events and infer a possible trend from that event. For example, if a particular customer orders too many of a particular item, then known enterprise application integration brokers will not alert a business to the trend that a customer is ordering too many items. The business will therefore not be alerted to a possible indication of fraud.

To address this problem, programs known as complex event processing engines have been developed to analyze multiple events and infer possible trends based on the occurrence and timing of the multiple events. However, the complex event processing engines are stand-alone programs that are not integrated with any known enterprise application integration broker. Thus, a user independently analyzes the output of a complex event processing engine. The user then manually adjusts the rules governing the enterprise application integration broker, if the user decides that the rules should be adjusted in response to the detected trend. No known enterprise application integration broker can perform complex event processing and then adjust the business process rules dynamically based on the insights gained from the complex event processing engine.

### SUMMARY OF THE INVENTION

The present invention provides a computer implemented method, apparatus, and computer program usable program code for defining an enterprise application integration broker. The enterprise application integration broker manages a number of applications. The enterprise application broker and the applications are established in at least one physical data processing system. The enterprise application integration broker includes a complex event processing engine established in the at least one physical data processing system. The complex event processing engine is adapted to monitor and analyze a first set of events occurring in at least one of the plurality of applications. In addition, the enterprise application integration broker includes an integration engine established in the at least one physical data processing system. The integration engine is connected to the complex event processing engine and is connected to each of the applications. The integration engine is adapted to cause at least one application to react to the first set of events. The integration engine is further adapted to cause at least one application to react to a second set of events generated by the complex event processing engine. In this illustrative example, the second set of events is correlated with the first set of events.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a network of data processing systems in which aspects of the present invention may be implemented;

FIG. 2 is a block diagram of a data processing system in which aspects of the present invention may be implemented;

FIG. 3 is a block diagram of an enterprise application integration broker platform, in accordance with an illustrative example of the present invention;

FIG. 4 is a flowchart illustrating use of the enterprise application integration broker platform shown in FIG. 3, in accordance with an illustrative example of the present invention;

FIG. 5 is a flowchart illustrating a process of defining an enterprise application integration broker, in accordance with an illustrative example of the present invention;

FIG. 6 is a flowchart illustrating an exemplary process of determining a location where events are monitored with business probes, in accordance with an illustrative example of the present invention;

FIG. 7 is a flowchart illustrating an exemplary process of creating a set of complex event processing business rules, in accordance with an illustrative example of the present invention; and

FIG. 8A is a block diagram representing an exemplary data flow that occurs when modifying an enterprise application integration broker in response to an event.

FIG. 8B is a block diagram representing an exemplary data flow that occurs when modifying an enterprise application integration broker in response to an event.

### DETAILED DESCRIPTION OF THE PREFERRED EMBODIMENT

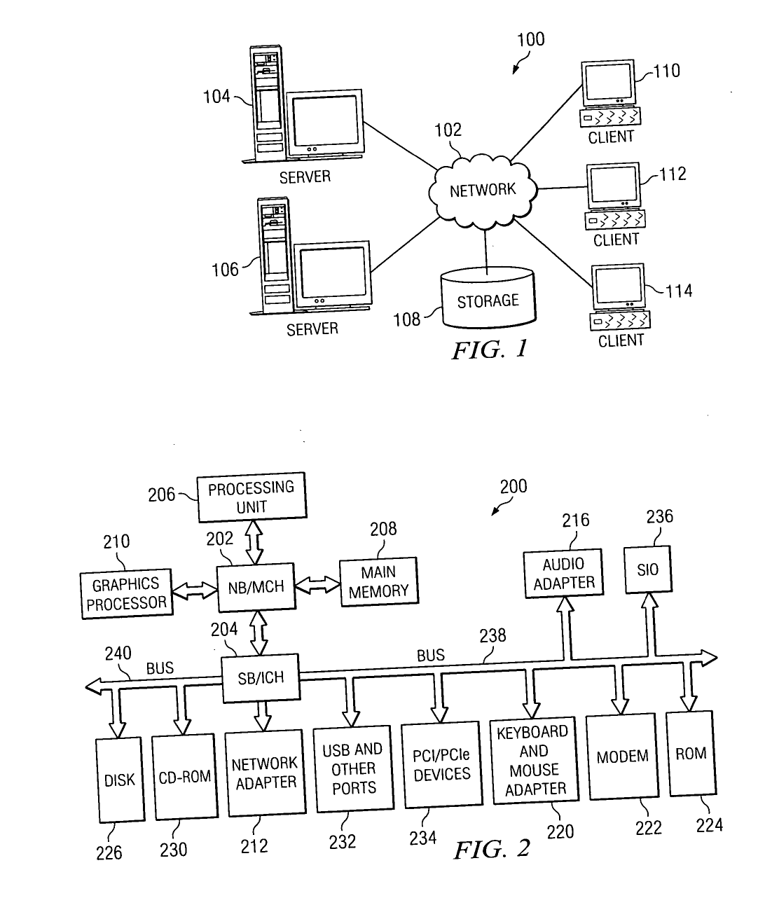

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers or data processing systems in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for transmission of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provides a computer implemented method, apparatus, and computer usable program code for defining an enterprise application integration broker. The enterprise application integration broker manages a number of applications, such as applications for managing retail orders. The enterprise application broker and the applications are established in at least one physical data processing system. The enterprise application integration broker, in these examples, includes a complex event processing engine established in the at least one physical data processing system. The complex event processing engine is adapted to monitor and analyze a first set of events in at least one of the plurality of applications. An event can be any activity detected by an application, enterprise application integration broker, or complex event processing engine; performed by an application, enterprise application integration broker, or complex event processing engine; or performed on an application, enterprise application integration broker, or complex event processing engine. For example, a first set of events might be a customer purchasing an item or a number of items. In addition, the enterprise application integration broker includes an integration engine established in the at least one physical data processing system. The integration engine is connected to the complex event processing engine and is connected to each of the applications.

The integration engine is adapted to cause at least one application to react to the first set of events. For example, the integration engine may cause a second application to cause the customer order to be filled at a warehouse. The integration engine is further adapted to cause at least one application to react to a second set of events generated by the complex event processing engine. For example, the integration engine might offer the customer a better price based on the number of past purchases the customer has made of the same item. In this case, the second set of events is a trend detected by the complex event processing engine, wherein the trend is increased customer purchasing activity. In this illustrative example, the second set of events is correlated with the first set of events. Thus, the event of purchasing an item is correlated with the event of detecting a trend of increased customer purchasing activity.

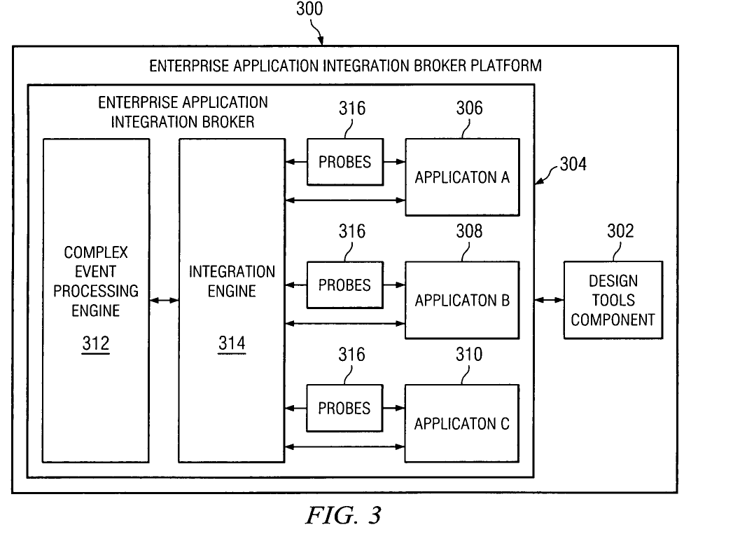

FIG. 3 is a block diagram of an enterprise application integration broker platform, in accordance with an illustrative example of the present invention. Enterprise application integration broker platform 300 shown in FIG. 3 may be implemented in one or more data processing systems, such as data processing system 200 shown in FIG. 2, server 104 in FIG. 1, or clients 110, 112, and 114 in FIG. 1. The data processing systems may be connected via a network, such as network 102 in FIG. 1. Each of data processing systems 104, 110, 112, 114, and 200 are physical data processing systems.

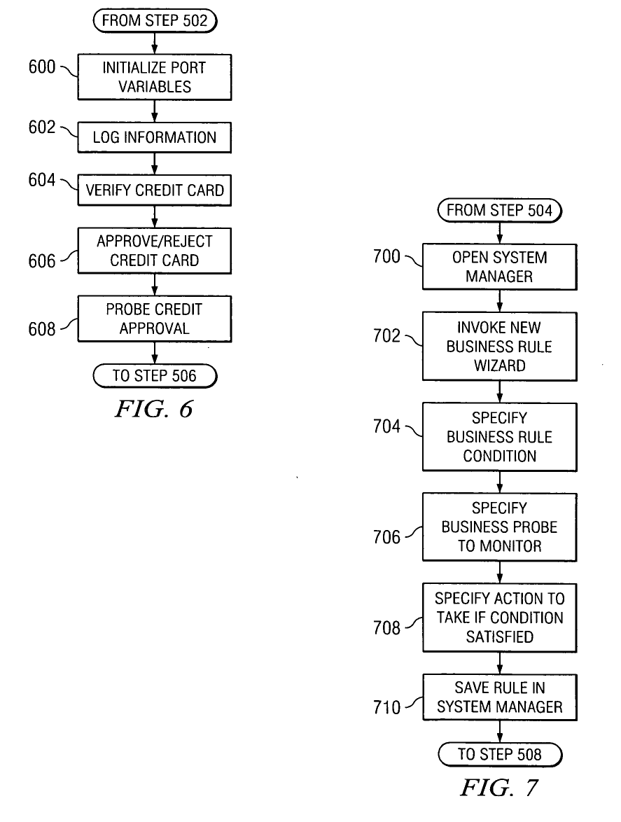

Enterprise application integration broker platform 300 includes design tools component 302 and enterprise application integration broker 304. Design tools component 302 contains tools a user may use to design the operation of enterprise application integration broker 304 and to define the rules of enterprise application integration broker 304. Design tools component 302 may be drag-and drop graphical icons that a user may manipulate to formulate integration engine rules and complex event processing engine rules. Enterprise application integration broker platform 300 is programmed to interpret the actions taken by the user with the graphical icons and to program integration engine 314 and complex event processing engine 312 accordingly. A number of probes 316, which may be stand-alone software applications or may be code within applications 306, 308, or 310 or within integration engine 314, communicate event information from applications 306, 308, and 310 to complex event processing engine 312 via integration engine 314. As described further below with respect to FIG. 6, probes gather event information at various points with respect to a defined business process.

Individually, these components are available as stand-alone products. For example, versions of design tools component 302, enterprise integration broker 304, integration engine 314, and complex event processing engine 312 are available. However, no known enterprise application integration broker platform 300 includes all of these elements and known platform is capable of both complex event processing and application integration or of dynamically changing applications based on insights gained from complex event processing.

Thus, design tool component 302 is adapted to configure at least one business rule for use by integration engine 314, wherein the at least one business rule defines how the at least one application reacts to a first set of events. Similarly, design tool component 302 is adapted to configure at least one business rule for use by complex event processing engine 314, wherein the at least one business rule defines how complex event processing engine 314 reacts to the first set of events to generate a second set of events. The second set of events causes enterprise application integration broker 304 to modify the behavior of applications 306, 308, and 310. In addition, the at least one business rule defined in complex event processing engine 312 also defines how the first set of events is correlated to the second set of events

Enterprise application integration broker 304 contains a number of disparate applications, including application A 306, application B 308, and application C 310. In addition, enterprise application integration broker 304 contains complex event processing engine 312 and integration engine 314. Enterprise application integration broker 304 coordinates the activities of each application and complex event processing engine 312 via integration engine 314.

Enterprise application integration broker 304 solves the problem of obtaining business insights out of individual business events flowing through applications 306, 308, 310, and through integration engine 314. A business insight is an inference gained from one or more events. Often, a business insight is gained from a trend; for example, a series of events or pattern of events within a predetermined time period can allow an inference or business insight that fraud is taking place, that a customer should receive a preferred status, or some other trend. A business insight may also be inferred from a single event.

In general, as described above, an event can be any activity performed by, on, or to an application, enterprise application integration broker, or complex event processing engine. Thus a “series of events” is one or more events that take place over a selected period of time. The selected period of time may be any time interval, such as a period of microseconds to a period of months or even years. A series of events can be sequential or non-sequential. A series of events can originate from the same application or object, or can originate from different applications at different points in a business process.

For example, if a customer places a single order for a large number of items, then an inference or business insight may be drawn that an opportunity for further business exists with that customer. A business insight may also be inferred from other events, such as type of products ordered, the time at which products were ordered, who ordered products, or other events associated with any application in enterprise application integration broker 304. The correlation of any such events with pre-selected conditions may be referred to as a business insight. Pre-selected conditions can include time limits, quantity limits, quotas, customer identifications, dollar amounts, or any other condition.

For example, enterprise application integration broker 304 may detect an event if a product is ordered. The event is communicated to complex event processing engine 312. The customer continues to order products. Complex event processing engine correlates the separate events to pre-selected conditions. In this case, the pre-selected conditions are a number of products ordered in a pre-determined time period. Continuing the example, the pre-selected conditions are the same customer ordering 100 products in a 24 hour time period. If the pre-selected conditions are satisfied for a given customer, then the complex event processing engine communicates this fact to integration engine 314. In turn, integration engine 314 dynamically changes one or more applications 306, 308, or 310. Continuing the example, if a customer orders 100 products in 24 hours, then integration engine 314 causes application A 306 to upgrade the customer status to a preferred customer, thereby giving that customer a reduced price on ordering future products.

Thus, complex event processing engine 312 uses one or more events communicated via integration engine 314 from applications 306, 308, and 310 to draw inferences regarding the one or more events. In turn the inferences provide business insights. Enterprise application integration broker 304 can respond appropriately to business insights by adjusting one or more of applications 306, 308, or 310 via integration engine 314. For example, if a business insight generated by complex event processing engine 312 indicates that fraud is taking place on a customer account, then integration engine 314 automatically causes one or more of applications 306, 308, and 310 to freeze the customer's account until the customer can verify the potentially fraudulent transactions.

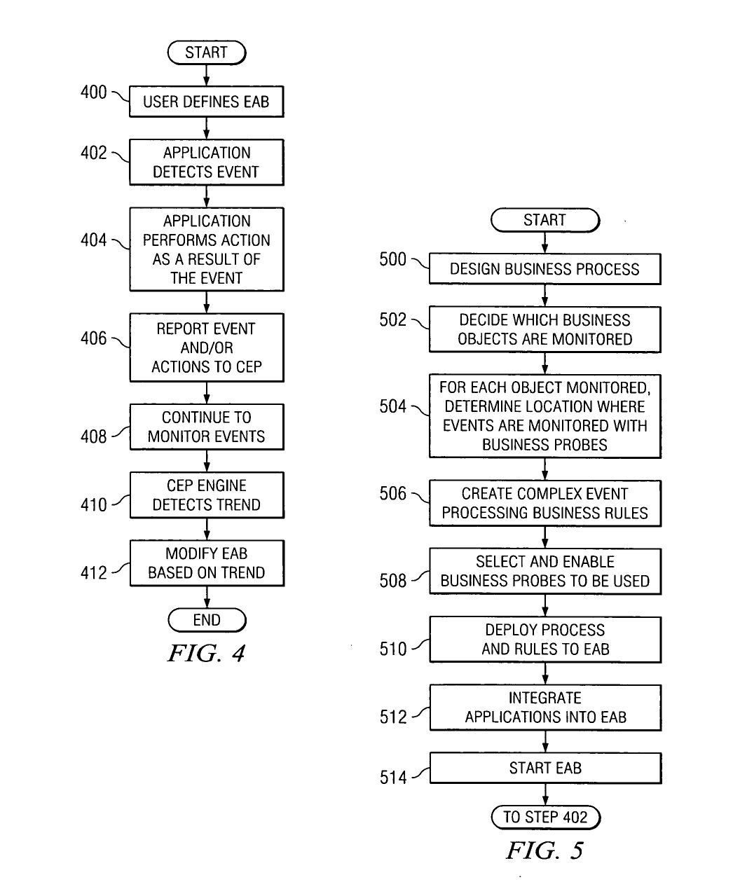

FIG. 4 is a flowchart illustrating use of the enterprise application integration broker platform shown in FIG. 3, in accordance with an illustrative example of the present invention. The process shown in FIG. 4 may be implemented in the various components of enterprise application integration broker platform 300 shown in FIG. 3

Initially, a user defines the enterprise application integration broker (EAB) using a design tool component, such as design tools component 302 in FIG. 3 (step 400). The process of defining the enterprise application integration broker is described further below with respect to FIGS. 5-7. After the user defines enterprise application integration broker, one or more applications detect an event in the enterprise application integration broker (step 402). An event may be any event as described above with respect to FIG. 3. For example, an event may be a customer ordering a product online via a credit card transaction.

Thereafter, one or more applications in the enterprise application integration broker perform one or more actions as a result of the event (step 404). The integration engine can coordinate these actions. Continuing the above example, as a result of the order event, one or more applications take action to receive the order. A series of actions in response to an event can include one or more commands to process the credit card transaction, cause the product to be shipped to the customer, record the revenue received, and adjust the record of the business' inventory accordingly. The integration engine may coordinate this series of actions.

Thereafter, the integration engine reports the event and/or the actions taken to the complex event processing engine (CEP) (step 406). The complex event processing engine records the event and/or actions and analyzes the event and/or actions to determine whether a trend or a business insight can be gained with respect to the event and/or actions or with respect to other similar past events and/or actions. The complex event processing engine continues to monitor events and/or actions in this manner (step 408). Eventually, the complex event processing engine detects a trend (step 410). The complex event processing engine can derive a business insight from the trend, depending on how the user defined the enterprise application integration broker in step 400.

Continuing the above example, the complex event processing engine logs one thousand events, each of which is a single order processed in one or more of the applications in the enterprise application integration broker. Of those one thousand events, one hundred events are associated with a first customer in a one hour period from a distant country and ten events are associated with a second customer in a twenty-four hour period from Canada. The complex event processing engine detects the events associated with both customers as trends. As a result of the definitions provided in step 400, the complex event processing engine determines two business insights. The first business insight is that the transactions associated with the first customer are likely to be fraudulent. The second business insight is that the transactions associated with the second customer likely point to a business opportunity with the second customer and also to general business opportunities in Canada.

As a result of the complex event processing engine detecting these trends, the integration engine causes one or more of the applications in the enterprise application integration broker to be modified (step 412). Continuing the above example, one or more applications in the enterprise application integration broker freeze the first customer's account until the transactions can be verified. At the same time, one or more applications in the enterprise application integration broker offer the second customer an improved price or other improved terms. In addition, one or more applications in the enterprise application integration broker also offer any customer in Canada an improved price or other improved terms. Thus, a single enterprise application integration broker platform can integrate applications, perform complex event processing, and dynamically modify those applications in response to business insights determined from the complex event processing.

FIG. 5 is a flowchart illustrating a process of defining an enterprise application integration broker, in accordance with an illustrative example of the present invention. The process shown in FIG. 5 illustrates defining an enterprise application integration broker in step 400 of FIG. 4. The process shown in FIG. 5 may be implemented in enterprise application integration broker platform 300, using design tools component 302, as shown in FIG. 3.

Initially, a business analyst or other user designs a business process (step 500). The business process is a series of events, activities, or rules that define a business goal. Thus, the business process is a flow. For example, the following criteria may define a flow. First, the complex event processing engine tracks the total accumulated value of orders for each customer. Second, if the dollar amount for a given customer eventually exceeds $300 in one year, then the enterprise application integration broker prompts an application to promote the customer to gold member status. Third, if a customer is promoted to gold member status, then the enterprise application integration broker prompts an application to offer that customer a 10% discount on all purchases and offer the customer free shipping. Together, the three rules of the business process can be referred to as a collaboration template. The collaboration template will eventually be implemented in the complex event processing engine, as described below. The flow is established using design tools component 302 in FIG. 3, such as graphical design icons and/or other forms for accepting user input.

After the user designs the business process, the user or an application decides which business objects are to be monitored for each business rule in the collaboration template (step 502). A business object is a construct or mechanism used to represent the data from any application in the enterprise application integration broker platform or any event. Continuing the above example, a user or application decides that a credit card processing collaboration template, or process, should be monitored and that each order business object processed by that application should be monitored.

Continuing the process shown in FIG. 5, for each object monitored, a user determines the location in the collaboration template where events are monitored using one or more business probes (step 504). A business probe is an application and is designed to monitor the operation of another application by sending the events to the complex event processing engine. A probe may be as simple as a few lines of code within an existing application that allow an application to communicate an event or an action to the integration engine. Continuing the above example, a business analyst or application determines that a business probe should be implemented in the credit card processing application at the point in the flow where a credit card is approved or denied. The business probe monitors when credit card orders are approved and monitors how much is charged to the credit card. The business probe is adapted to communicate this information to the integration engine, which in turn communicates this information to the complex event processing engine. This process is further described with respect to FIG. 6.

Next, the business analyst or an application creates complex processing business rules (step 506). The complex processing business rules are coded to implement the business process designed in step 500. A user authors the complex event processing business rules using a rules wizard in the design tools component, as described with respect to FIG. 7, such that a user need not be concerned with the actual programming language used to implement each complex processing business rule. The complex processing business rules determine the trends or insights that the complex event processing engine detects. An example of a coded rule is “PurchaseOrderProcessing_BP_CustomerOrder.totalAmount>3 00”. This coded rule checks to see if the total accumulated customer purchases total $300 or more.

After the complex processing business rules are created, the user or the application selects and enables those business probes to be used (step 508). In most cases, all probes located in the positions defined in step 504 will be selected and enabled. However, in some cases a user will want to operate only certain probes at any given time. Thus, the user is given the option to select and enable certain business probes.

Subsequently, a user or application causes the business process described in step 502 and the business rules created in step 506 to be deployed to the enterprise application integration broker (step 510). During this step, a user or an application configures the enterprise application integration broker to implement the rules created in step 506. Afterwards, all of the applications to be associated with and managed by the enterprise application integration broker are integrated into the enterprise application integration broker (step 512). The enterprise application integration broker starts and begins managing all of the applications, the integration engine, and the complex event processing engine (step 514). The process then continues to step 402, as described in FIG. 4.

FIG. 6 is a flowchart illustrating an exemplary process of determining a location where events are monitored with business probes, in accordance with an illustrative example of the present invention. The process shown in FIG. 6 illustrates determining the location of where events are monitored, as described in step 504 of FIG. 5. The process shown in FIG. 6 may be implemented in enterprise application integration broker platform 300, using design tools component 302, as shown in FIG. 3.

FIG. 6 shows an exemplary process of a business probe defined in a particular purchase order business process during a credit card transaction. From step 502 in FIG. 5, deciding which business objects are monitored, port variables in the pertinent application are initialized (step 600). Then, all of the processing order information is logged (step 602). During this step, the user enters credit card information and the credit card information the pertinent application receives the credit card information. Next, a verifying service verifies the credit card to ensure that the credit card is valid (step 604). In verifying, the credit card, the pertinent application then communicates with the corresponding credit card company to request approval for the transaction and, possibly, to request transfer of funds. The credit card company then approves or rejects the credit card transaction (step 606). In this illustrative example, the credit card company approves the credit card and the transaction proceeds accordingly.

Next, a business probe probes the information that credit card approval (step 608). The business probe communicates the fact that an order has been approved or rejected to the integration engine. The business probe can also communicate to the integration engine what items or services were purchased and the dollar amount of the transaction. While the latter two types of information may be probed at step 608, they may also be probed at other steps in the business process. The integration engine, in turn, passes the information to the complex event processing engine and also uses the information to manage other applications in the enterprise application integration broker. In other examples, the business probe or probes pass information directly to the complex event processing engine or to only one of the integration engine and the complex event processing engine. In any case, after a probe probes the credit card approval, the process returns to step 506 in FIG. 5.

FIG. 7 is a flowchart illustrating an exemplary process of creating a set of complex event processing business rules, in accordance with an illustrative example of the present invention. The process shown in FIG. 7 illustrates creating complex event processing business rules, as described in step 506 of FIG. 5. The process shown in FIG. 7 may be implemented in enterprise application integration broker platform 300, using design tools 302, as shown in FIG. 3.

Initially, a user opens a system manager in a set of design tools, such as design tools 302 in FIG. 3 (step 700). The system manager stores all of the integration artifacts in the enterprise application integration broker. The user then invokes a new business rule wizard in design tools 302 (step 702). The user then specifies the business rule conditions (step 704). For example, the specific values for a business rule condition may be a command such as “probeBusObj.orderTotal>$300” establishes “UpgradeGoldMember”, in which a Gold Member account carries certain privileges such as better prices. The user also specifies the business probes to monitor (step 706). The user also specifies the actions to take if stated conditions are satisfied (step 708). Finally, the user saves the rule in the system manager (step 710). The saved rule may be implemented in complex event processing engine 312 in FIG. 3. Thereafter, the process returns to step 508 in FIG. 5.

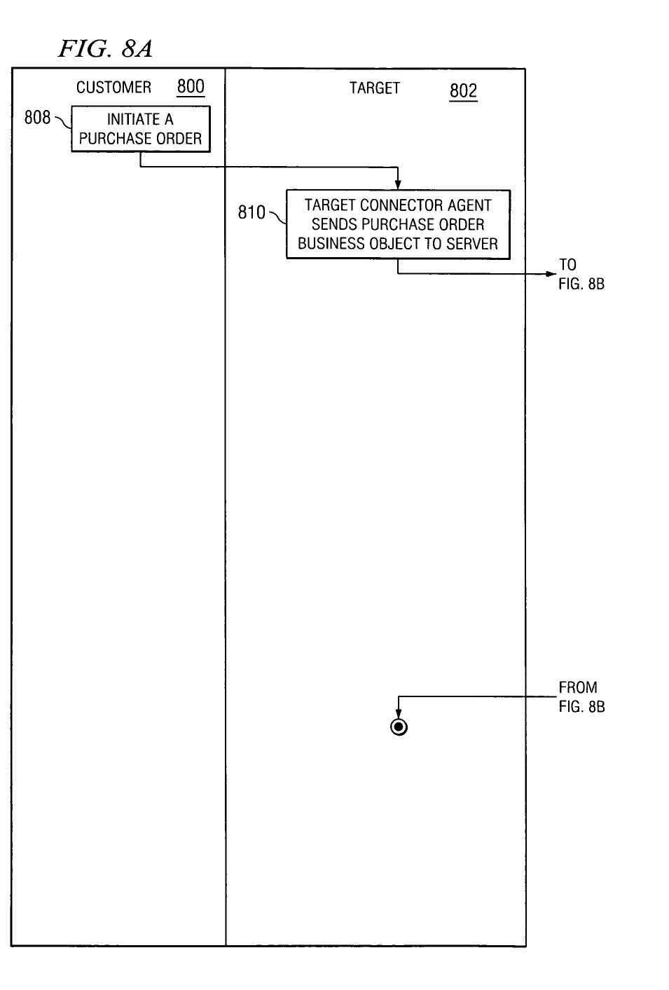

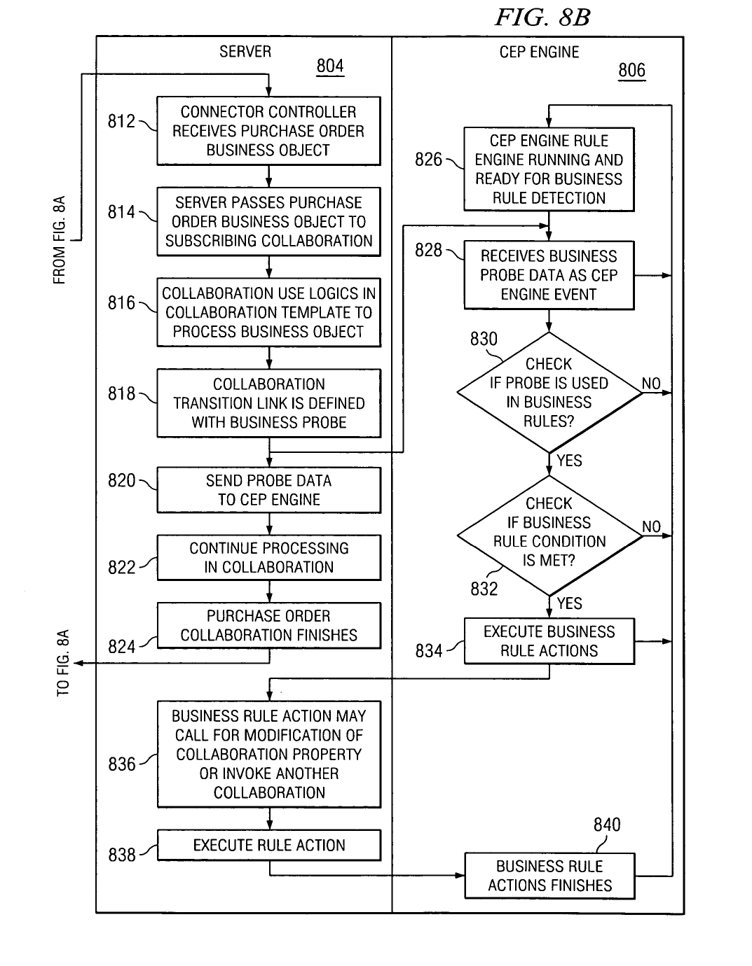

FIG. 8A and FIG. 8B are block diagrams representing an exemplary data flow that occurs when modifying an enterprise application integration broker in response to an event. The data flow shown in FIG. 8A and FIG. 8B may take place in an enterprise application integration broker, such as enterprise application integration broker 304 in FIG. 3. The data flow shown in FIG. 8A and FIG. 8B is described in the context of a specific transaction example. However, the data flow shown in FIG. 8A and FIG. 8B may be generalized for any set of business rules and any configuration of enterprise application integration broker 304 shown in FIG. 3.

In the following example, a company has advertised the following promotion: “Spend more than $300 in the next six weeks and you will be promoted to Gold Membership free of charge. A Gold Membership entitles you to a 10% discount on all products purchased.” In response, a business analyst in the company implements this promotion in the company's existing applications and data processing systems via an enterprise application integration broker platform, such as that shown in FIG. 3. The business analyst, who is the user, implements the promotion using design tools 302 according to the methods shown in FIG. 5 through FIG. 7.

As shown in FIG. 8A and FIG. 8B, the data flow begins with a customer 800 initiating a purchase order at block 808. Communication software routes purchase order to target 802, which may be one or more applications running on one or more data processing systems. Target 802 is adapted to process a part or all of customer order 808. Then, a target connector agent sends a purchase order business object to an enterprise application integration broker on a server operated by the company at block 810. A connector is an application that interacts with another application, such as target 802, and converts the application business data into a business event format that can be recognized by an enterprise application integration broker. A purchase order business object is a set of data that contains information relating to the purchase order.

Next, a connector controller receives the purchase order business object in block 812. The connector controller runs on server 804. Server 804 then passes the purchase order business object to a subscribing collaboration template, such as the collaboration template described vis-à-vis FIG. 5 and FIG. 3, at block 814. As described above, a collaboration template is a flow or business process template implemented in the enterprise application integration broker. The collaboration template then uses the rules logic contained in the collaboration template to process the business object at block 816.

A user defines a collaboration transition link with a business probe at block 818. A user or application implements business probe at a location in the business process, normally a transition link, where the user has decided that an event needs to be sent to an external engine for further inferences or insights. In this case, the external engine is the complex event processing engine. An integration engine then sends probe data to complex event processing engine 806 for further processing, as described below. The probe data has a format usable by the complex event processing engine. The probe data contains any information needed by the receiving complex processing engine to make possible some inference. Processing of the business object continues in the collaboration template at block 822. When the purchase order collaboration template has finished implementing all rules relating to the business object at block 824, the process terminates.

Turning now to complex event processing engine 824, the complex event processing engine is adapted to perform complex event processing, as described vis-à-vis FIG. 3. Complex event processing engine 806 is running and ready for business rule detection at block 826 when probe data is sent to complex event processing engine 806 at block 820. Complex event processing engine receives the business probe data as an event at block 828.

At block 830, an integration engine then determines whether the probe is used in the business rules established in complex event processing engine 806. If the probe is not used in the business rules, then data flow ends and complex event processing engine continues to wait for detection of a business rule at block 826. If a business rule does apply, the integration engine determines whether a business rule condition is met at block 832. If a business rule condition has not been met, then data flow ends and complex event processing engine continues to wait for detection of a business rule at block 826. If a business rule condition has been met, then at block 834 the complex event processing engine causes the enterprise application integration broker to execute the pre-defined actions in one or more applications. An action can be any activity performed by or on an application, including applications within an enterprise application integration broker platform, the enterprise application integration broker itself, or the complex event processing engine. For example, an activity can be to process a credit card transaction, generate an offer, present an offer a customer, modify an application to no longer accept transactions from a particular customer, shut down an application, start an application, or any other activity, initiate a pre-determined business rule, generate a business rule, or co-ordinate other activities of other applications.

A business rule action may call for modification of a collaboration template, may invoke another collaboration template, or may take some other action to modify or provide data to one or more applications associated with the enterprise application integration broker, as shown in block 836. A server, such as server 804 executes the process of acting on the business rule at block 838. The business rule actions then finish, at block 840, and the integration engine can report the actions taken to complex event processing engine 806. Thereafter, the data flow terminates and the complex event processing engine continues to wait for detection of an event, as shown in block 826.

In addition, the entire process described above with respect to FIG. 8A and FIG. 8B can repeat after customer 800 initiates another purchase order at block 808. In response, the complex event processing engine can track the second purchase and apply different collaboration templates based on the fact that the complex event processing engine has detected more than one event within a given time period.

Thus, in the above example, an enterprise application integration broker manages a plurality of applications, wherein the enterprise application broker and the plurality of applications are established in at least one physical data processing system. The enterprise application integration broker includes a complex event processing engine established in the at least one physical data processing system, the complex event processing engine adapted to monitor and analyze a first set of events occurring in at least one of the plurality of applications. In the above example, the first set of events is a first purchase order, a second purchase order, and the dollar amount of each purchase order. The complex event processing engine analyzes the first order and the second order to detect a trend, such as the total amount spent for purchase orders or the total amount spent in a pre-determined time period.

The enterprise application integration broker also includes an integration engine established in the at least one physical data processing system. The integration engine is connected to the complex event processing engine and connected to each of the plurality of applications. The integration engine is adapted to cause at least one application in the plurality of applications to react to the first set of events. The integration engine is further adapted to cause at least one application in the plurality of applications to react to a second set of events generated by the complex event processing engine. In the above example, the second set of events may be a command by the complex event processing engine to cause the applications associated with the integration engine to provide a customer with a 10% discount on future purchases and free shipping on future purchases. The second set of events is correlated with the first set of events in that the two purchase orders triggered business rules in the complex event processing engine to offer a discount and free shipping on future purchases.

In use, a method of integrating a plurality of applications running on at least one data processing system includes the following steps. First, an enterprise application broker is defined, the enterprise application broker having a first set of business rules that define how each application in the plurality of applications reacts to an event in at least one of the applications in the plurality of applications. Second, a first event is detected in at least one of the applications. Third, responsive to detecting the first event, an action is performed in at least one application in the plurality of applications according to the first set of business rules. Fourth, a complex event processing engine is notified of the first event, the complex event processing engine being integrated with the enterprise application broker. Fifth, a second event is detected in at least one of the applications. Sixth, responsive to detecting the second event, an action is performed in at least application in the plurality of applications according to the first set of business rules. Seventh, the complex event processing engine is notified of the second event. Eight, the first event and the second event are correlated using the complex event processing engine according to a second set of business rules to form a correlated event. Ninth, the first set of business rules is modified according to a third set of business rules, the third set of business rules defining how the first set of business rules are modified in response to the correlated event.

In addition, a computer implemented method for processing events generated by a plurality of applications has been described. The method includes monitoring a business process for the events generated by the plurality of applications; determining whether a particular series of events over a selected period of time is present in the events; and responsive to detecting a particular series of events over a selected period of time, executing an action with respect to the plurality of applications. One or more computers implement the step of executing an action with respect to the plurality of applications.

The aspects of the present invention have several advantages over known enterprise application integration brokers. No known enterprise application integration broker combines the capabilities of an integration engine and a complex event processing engine. Thus, the different aspects of the present invention allow applications managed by an integration engine to be modified or to be given different instructions continuously based on trends detected by the complex event processing engine. As a result, aspects of the present invention allow businesses greater power to implement promotions automatically and with a minimum of difficulty.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for processing events for a plurality of applications, the computer implemented method comprising:
monitoring a business process for the events for the plurality of applications;
determining whether a particular series of events over a selected period of time is present in the events; and
responsive to detecting the particular series of events over the selected period of time, executing an action with respect to the plurality of applications.

2. The method of claim 1 further comprising:
defining an enterprise application integration broker, the enterprise application integration broker having a first set of business rules that define how each application in the plurality of applications reacts to the events.

3. The method of claim 2 wherein the steps of monitoring, determining, and executing are performed by the enterprise application integration broker.

4. The method of claim 2 wherein the step of defining an enterprise application integration broker further comprises:
designing a business process;
deciding which of a plurality of business objects are monitored;
for each of the plurality of business objects, determining a location in the business process where events are monitored;
creating the first set of business rules; and
enabling at least one business probe used for monitoring the events.

5. The method of claim 4 wherein the business process comprises processing a credit card order and wherein the step of determining a location in the business process where events are monitored further comprises:
initializing at least one port variable in the at least one data processing system;
logging event information, the event information comprising processing of the credit card order;
verifying approval of the credit card; and
monitoring for whether the credit card was approved.

6. The method of claim 4 wherein the step of creating the first set of business rules further comprises:
opening a system manager of a user application;
invoking a new business rule wizard;
specifying a first set of conditions for the first set of business rules;
specifying business probes to monitor for the events; and
specifying an action for the enterprise application integration broker to take if the first set of conditions are satisfied.

7. The method of claim 1 wherein a complex event processing engine performs the step of determining whether the particular series of events over the selected period of time is present in the events.

8. The method of claim 7 wherein the particular series of events comprises a trend.

9. The method of claim 8 further comprising:
defining an enterprise application integration broker, the enterprise application integration broker having a first set of business rules that define how each application in the plurality of applications reacts to the events, wherein the steps of monitoring, determining, and executing are performed by the enterprise application integration broker; and
modifying the first set of business rules according to a second set of business rules, the second set of business rules defining how the first set of business rules are modified in response to the trend.

10. A computer program product comprising:
a computer usable medium having computer usable program code for integrating a plurality of applications running on at least one data processing system, the computer program product including:
computer usable program code for defining an enterprise application integration broker, the enterprise application integration broker having at a first set of business rules that define how each application in the plurality of applications reacts to an event in at least one of the applications in the plurality of applications;
computer usable program code for detecting a first event in at least one of the applications;
computer usable program code for, responsive to detecting the first event, performing an action in at least one application in the plurality of applications according to the first set of business rules;
computer usable program code for notifying a complex event processing engine of the first event, the complex event processing engine integrated with the enterprise application integration broker;
computer usable program code for detecting a second event in at least one of the applications;
computer usable program code for, responsive to detecting the second event, performing an action in at least application in the plurality of applications according to the first set of business rules;
computer usable program code for notifying the complex event processing engine of the second event;
computer usable program code for correlating the first event and the second event using the complex event processing engine according to a second set of business rules to form a correlated event; and
computer usable program code for modifying the first set of business rules according to a third set of business rules, the third set of business rules defining how the first set of business rules are modified in response to the correlated event.

11. The computer program product of claim 10 wherein the computer usable program code for defining an enterprise application integration broker further comprises:
computer usable program code for designing a business process;
computer usable program code for deciding which of a plurality of business objects are monitored;
computer usable program code for determining, for each of the plurality of business objects, a location in the business process where events are monitored;
computer usable program code for creating the first set of business rules, the second set of business rules, and the third set of business rules; and
computer usable program code for selecting and enabling at least one business probe used for monitoring the events.

12. The computer program product of claim 11 wherein the business process comprises processing a credit card order and wherein the computer usable program code for determining a location in the business process where events are monitored further comprises:
computer usable program code for initializing at least one port variable in the at least one data processing system;
computer usable program code for logging event information, the event information comprising processing of a credit card order;
computer usable program code for verifying approval of the credit card; and
computer usable program code for monitoring for whether the credit card was approved.

13. The computer program product of claim 11 wherein the computer usable program code for creating the first set of business rules, the second set of business rules, and the third set of business rules further comprises:
computer usable program code for opening a system manager of a user application;
computer usable program code for invoking a new business rule wizard;
computer usable program code for specifying the first set of business rules, for specifying a first set of conditions for the second set of business rules, and for specifying a second set of conditions for the third set of business rules;
computer usable program code for specifying business probes to monitor for the first event and the second event; and
computer usable program code for specifying an action for the enterprise application integration broker to take if the first set of conditions and the second set of conditions are satisfied.

14. An enterprise application integration broker for managing a plurality of applications comprising:
a complex event processing engine established in the at least one physical data processing system, the complex event processing engine adapted to monitor and analyze a first set of events occurring in at least one of the plurality of applications; and
an integration engine established in the at least one physical data processing system, the integration engine connected to the complex event processing engine and connected to each of the plurality of applications, wherein the integration engine is adapted to cause at least one application in the plurality of applications to react to the first set of events, wherein the integration engine is further adapted to cause at least one application in the plurality of applications to react to a second set of events generated by the complex event processing engine, and wherein the second set of events is correlated with the first set of events.

15. The enterprise application integration broker of claim 14 further comprising:
a design tool component established in the at least one data processing system, the design tool component adapted to configure at least one business rule for use by the integration engine, wherein the at least one business rule defines how the at least one application reacts to the first set of events.

16. The enterprise application integration broker of claim 14 further comprising:
a design tool component established in the at least one data processing system, the design tool component adapted to configure at least one business rule for use by the complex event processing engine, wherein the at least one business rule defines how the first set of events is correlated to the second set of events.

17. The enterprise application integration broker of claim 14 further comprising:
a design tool component established in the at least one data processing system, the design tool component adapted to configure a first set of business rules for use by the integration engine, wherein the first set of business rules define how the at least one application reacts to the first set of events, and wherein the design tool component is further adapted to configure a second set of business rules for use by the complex event processing engine, wherein the second set of business rules define how the first set of events is correlated to the second set of events.

18. The enterprise application integration broker of claim 15 wherein the design tool component is displayed to a user in a graphical form and is adapted for receiving user input.

19. The enterprise application integration broker of claim 16 wherein the design tool component is displayed to a user in a graphical form and is adapted for receiving user input.

20. The enterprise application integration broker of claim 17 wherein the design tool component is displayed to a user in a graphical form and is adapted for receiving user input.
